(19) United States
(12) Patent Application Publication
(10) Pub. No.: US 2025/0140952 A1
(43) Pub. Date: May 1, 2025

(54) BATTERY CONTROL DEVICE AND BATTERY CONTROL METHOD

(71) Applicant: HONDA MOTOR CO., LTD., Tokyo (JP)

(72) Inventors: Tatsunori Makino, Tokyo (JP); Natsuki Ehara, Tokyo (JP)

(21) Appl. No.: 18/903,399

(22) Filed: Oct. 1, 2024

(30) Foreign Application Priority Data
Nov. 1, 2023 (JP) 2023-187693

(51) Int. Cl. H01M 10/44; B60L 53/10; B60L 58/15; G06F 8/65

(52) U.S. Cl. CPC H01M 10/446; B60L 53/11; B60L 58/15; G06F 8/65

(57) ABSTRACT

A battery control device includes: an acquisition unit that acquires predetermined information including information on an update operation, which is an operation related to program update of an in-vehicle device mounted on a vehicle, and information on the remaining charge amount of the target battery; an execution unit that executes the charging operation; and a determination unit that determines whether or not to execute the charging operation in the execution unit after end of the update operation. The execution unit stops the charging operation when the update operation is started. The determination unit performs start determination as to whether or not to start the charging operation after the end of the started update operation, based on at least the information on the remaining charge amount of the target battery, during a period from a request for the update operation to the start of the update operation.

### INCORPORATION BY REFERENCE

The present application claims priority under 35 U.S.C. § 119 to Japanese Patent Application No. 2023-187693 filed on Nov. 1, 2023. The content of the application is incorporated herein by reference in its entirety.

### BACKGROUND

### Technical Field

The present invention relates to a battery control device and a battery control method.

### Related Art

In recent years, research and development that contribute to energy efficiency have been conducted so that more people can access energy that is affordable, reliable, sustainable, and advanced.

CN 114879996 A describes a remote version upgrade control system that stops a charging operation during the version upgrade process of an in-vehicle ECU through an OTA and continues charging after the version upgrade is completed.

### SUMMARY

By the way, in the present technology, it is an issue to prevent a reduction in the charging efficiency or the state of health (SOH) of an in-vehicle battery. For example, when the charging operation for the in-vehicle battery is interrupted when an update operation such as program update of the in-vehicle device is executed by over the air (OTA) or the like, there is a concern that the charging efficiency or the state of health of the in-vehicle battery may be reduced due to an increase in the number of times of charging and discharging due to the interruption.

In order to solve the above problem, an object of the present application is to suppress a reduction in the charging efficiency and/or the state of health of an in-vehicle battery while enabling quick charging required for the in-vehicle battery after the end of an update operation when a charging operation for the in-vehicle battery is interrupted during the update operation of the in-vehicle device. This ultimately contributes to energy efficiency.

One aspect of the present invention is a battery control device that controls a charging operation for a target battery that is one battery mounted on a vehicle. The battery control device includes: an acquisition unit that acquires predetermined information including information on an update operation, which is an operation related to program update of an in-vehicle device mounted on the vehicle, and information on a remaining charge amount of the target battery; an execution unit that executes the charging operation; and a determination unit that determines whether or not to execute the charging operation in the execution unit after end of the update operation. The execution unit stops the charging operation when the update operation is started. The determination unit performs start determination as to whether or not to start the charging operation after end of the started update operation, based on at least the information on the remaining charge amount of the target battery, during a period from a request for the update operation to start of the update operation.

According to another aspect of the present invention, in the start determination, when an actual remaining charge amount that is an actual remaining charge amount of the target battery at the time of request for the update operation is equal to or less than a first threshold value set in advance to avoid shortening of a life of the target battery by avoiding an overcharged state of the target battery, the determination unit determines to start the charging operation after the end of the update operation. When the actual remaining charge amount at the time of request for the update operation exceeds the first threshold value, the determination unit determines not to start the charging operation after the end of the update operation.

According to another aspect of the present invention, the predetermined information includes information on a predicted remaining charge amount that is a predicted value of the remaining charge amount of the target battery at the end of the update operation and information on an appropriate temperature range that is a temperature range of the target battery in which a charging efficiency, which is a ratio of an increase amount of the remaining charge amount to a power supply amount, in the target battery is equal to or greater than a predetermined value set in advance. In the start determination, even if the actual remaining charge amount at the time of request for the update operation is equal to or less than the first threshold value, when the predicted remaining charge amount is equal to or greater than a predetermined second threshold value, which is set in advance as a remaining charge amount that guarantees activation of the vehicle, and a temperature of the target battery exceeds an upper limit temperature of the appropriate temperature range or is less than a lower limit temperature of the appropriate temperature range, the determination unit determines not to start the charging operation after the end of the update operation.

According to another aspect of the present invention, when an actual remaining charge amount that is an actual remaining charge amount of the target battery at the end of the update operation becomes equal to or less than a third threshold value that is smaller than the second threshold value and is set in advance as a remaining charge amount with which it is difficult to guarantee activation of the vehicle, the execution unit starts the charging operation regardless of a result of the start determination in the determination unit.

According to another aspect of the present invention, the predetermined information includes information on a predicted end time that is a time at which the update operation is predicted to end and information on a non-use time zone in which a user of the vehicle is predicted not to use the vehicle. In the start determination, on condition that the actual remaining charge amount at the time of request for the update operation is equal to or less than the first threshold value, when the predicted end time is not included in the non-use time zone, the determination unit determines not to start the charging operation after the end of the update operation, and when the predicted end time is included in the non-use time zone, the determination unit determines to start the charging operation after the end of the update operation.

According to another aspect of the present invention, the predetermined information includes information on a predicted remaining charge amount that is a predicted value of the remaining charge amount of the target battery at the end of the update operation. In the start determination, in a case where the actual remaining charge amount at the time of request for the update operation is equal to or less than the first threshold value and the predicted remaining charge amount is equal to or greater than a second threshold value that is smaller than the first threshold value and is set in advance as a remaining charge amount that guarantees activation of the vehicle, when the predicted end time is not included in the non-use time zone, the determination unit determines not to start the charging operation after the end of the update operation, and when the predicted end time is included in the non-use time zone, the determination unit determines to start the charging operation after the end of the update operation.

According to another aspect of the present invention, when an actual remaining charge amount that is an actual remaining charge amount of the target battery at the end of the update operation becomes equal to or less than a third threshold value that is smaller than the second threshold value and is set in advance as a remaining charge amount with which it is difficult to guarantee activation of the vehicle, the execution unit starts the charging operation regardless of a result of the start determination in the determination unit.

According to another aspect of the present invention, the predetermined information includes information on a predicted end time that is a time at which the update operation is predicted to end. At the time of request for the update operation, the acquisition unit acquires, from a terminal device of a user of the vehicle, a first scheduled departure time that is a departure time of the vehicle scheduled by the user at the time of request for the update operation. In the start determination, when the actual remaining charge amount at the time of request for the update operation is equal to or less than the first threshold value and a time from the predicted end time to the first scheduled departure time is equal to or longer than a predetermined time set in advance, the determination unit determines to start the charging operation after the end of the update operation, and when the actual remaining charge amount at the time of request for the update operation is equal to or less than the first threshold value and the time from the predicted end time to the first scheduled departure time is less than the predetermined time set in advance, the determination unit determines not to start the charging operation after the end of the update operation.

According to another aspect of the present invention, the predetermined information includes information on a predicted remaining charge amount that is a predicted value of the remaining charge amount of the target battery at the end of the update operation. In the start determination, even if the actual remaining charge amount at the time of request for the update operation is equal to or less than the first threshold value and the time from the predicted end time to the first scheduled departure time is equal to or greater than the predetermined time, when the predicted remaining charge amount is equal to or greater than a second threshold value that is smaller than the first threshold value and is set in advance as a remaining charge amount that guarantees activation of the vehicle, the determination unit determines not to start the charging operation after the end of the update operation.

According to another aspect of the present invention, when the actual remaining charge amount at the time of request for the update operation is equal to or less than the first threshold value and the time from the predicted end time to the first scheduled departure time is equal to or greater than the predetermined time, the predicted remaining charge amount is equal to or greater than the second threshold value, and the determination unit determines not to start the charging operation after the end of the update operation. The acquisition unit acquires a second scheduled departure time, which is a departure time of the vehicle scheduled by the user at the end of the update operation, from the terminal device of the user at the end of the update operation. When a time from the end time of the update operation to the second scheduled departure time is longer than a predetermined time and an actual remaining charge amount, which is an actual remaining charge amount of the target battery at the end of the update operation, is less than the second threshold value, the execution unit starts a charging operation for the target battery regardless of a result of the start determination in the determination unit.

According to another aspect of the present invention, the target battery is charged from a high-voltage battery having a higher output voltage than the target battery and mounted on the vehicle.

Another aspect of the present invention is a battery control method executed by a computer of a battery control device that controls a charging operation for a target battery that is one battery mounted on a vehicle. The battery control method includes: a first step of acquiring predetermined information including information on an update operation, which is an operation related to program update of an in-vehicle device mounted on the vehicle, and information on a remaining charge amount of the target battery; a second step of stopping the charging operation when the update operation is started; and a third step of determining whether or not to execute the charging operation after end of the update operation. In the third step, start determination as to whether or not to start the charging operation after end of the started update operation is performed, based on at least the information on the remaining charge amount of the target battery, during a period from a request for the update operation to start of the update operation.

According to the present invention, even when the charging operation for the in-vehicle battery is interrupted during the update operation of the in-vehicle device, it is possible to suppress a reduction in the charging efficiency and/or the state of health of the in-vehicle battery while enabling quick charging required for the in-vehicle battery after the end of the update operation.

### BRIEF DESCRIPTION OF DRAWINGS

FIG. 1 is a diagram illustrating the schematic configuration of a vehicle including a battery control device according to an embodiment of the present invention;

FIG. 2 is a diagram illustrating the configurations of a battery control device and an update management device;

FIG. 3 is a flowchart illustrating the procedure of a battery control method executed by a computer of the battery control device; and

FIG. 4 is a flowchart illustrating the procedure of specific processing of a start determination process illustrated in FIG. 3.

### DETAILED DESCRIPTION

Hereinafter, an embodiment of the present invention will be described with reference to the diagrams.

### 1. Embodiment

### 1.1 Configuration of Vehicle

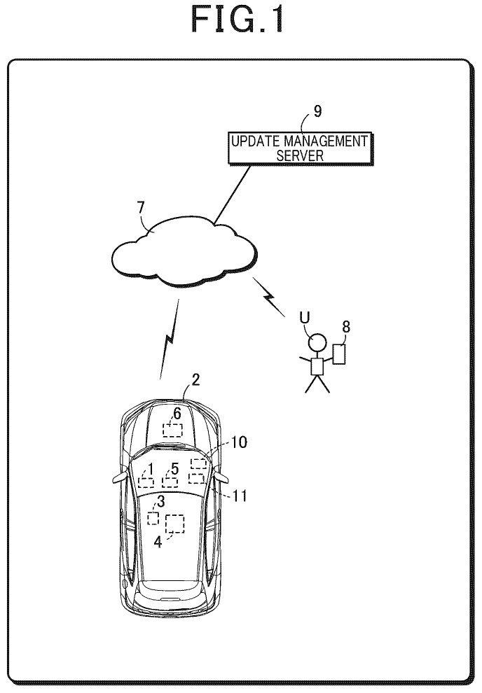

FIG. 1 is a diagram illustrating the schematic configuration of a vehicle 2 including a battery control device 1 according to an embodiment of the present invention. The vehicle 2 includes the battery control device 1, a low-voltage battery 3, a high-voltage battery 4, and an update management device 5. The vehicle 2 is, for example, an electric vehicle that travels by a motor for traveling 6. The high-voltage battery 4 is, for example, a battery that supplies driving power of the motor for traveling 6. The high-voltage battery 4 can be a battery charged by external power supply from a power supply device provided outside the vehicle 2, or a fuel cell that generates power using hydrogen fuel or the like.

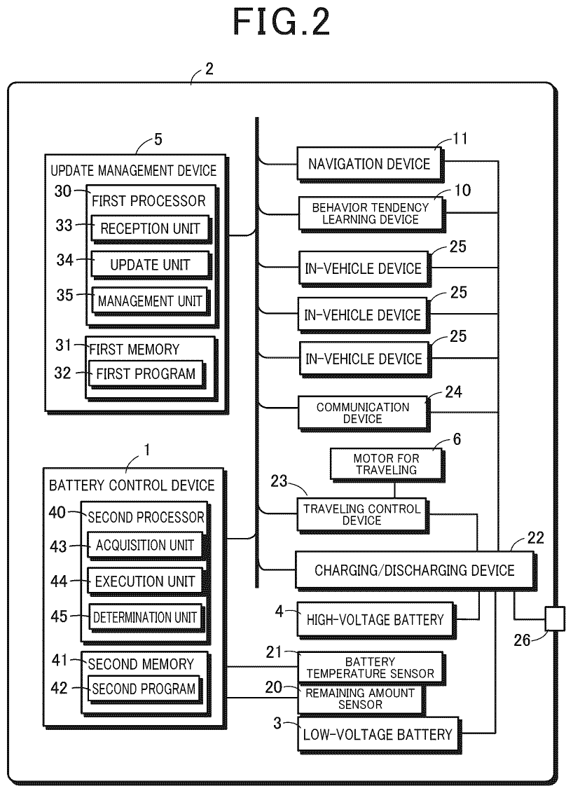

The low-voltage battery 3 is charged from the high-voltage battery 4 having a higher output voltage than the low-voltage battery 3. The low-voltage battery 3 supplies power necessary for starting the vehicle 2 and power necessary for controlling the traveling of the vehicle 2 to various in-vehicle devices 25 (FIG. 2) of the vehicle 2 described later.

The battery control device 1 controls a charging operation for the low-voltage battery 3 using the low-voltage battery 3 as a target battery. In addition, the battery control device 1 communicates with a terminal device 8 of a user U of the vehicle 2 through a communication network 7 provided outside the vehicle 2. The terminal device 8 is, for example, a mobile terminal such as a smartphone.

The update management device 5 manages operations related to program update by the OTA for the various in-vehicle devices 25 (see FIG. 2) of the vehicle 2. Specifically, the update management device 5 communicates with an update management server 9 through the communication network 7, and receives and stores an update instruction and an update program for the in-vehicle device 25 from the update management server 9. The update management device 5 instructs the in-vehicle device 25, which is an update target, to install the stored update program at a predetermined timing. The configuration of the update management device 5 will be described later.

The vehicle 2 may also include a behavior tendency learning device 10 that learns a daily behavior tendency of the user U of the vehicle 2 using the vehicle 2. The behavior tendency learning device 10 includes a computer and a memory. For example, the behavior tendency learning device 10 performs machine learning of a non-use time zone, which is a time zone within a day or a time zone for each day of the week in which the user U often does not use the vehicle 2, in units of one day or one week based on the location information of the vehicle 2 for each time obtained from a navigation device 11 (computer) when the user U uses the vehicle 2 by using the computer. This machine learning can be performed using AI, for example. Alternatively, instead of machine learning, the non-use time zone may be determined by a statistical processing method.

The battery control device 1 can acquire information on the non-use time zone from the behavior tendency learning device 10 and use the information to control the charging operation for the low-voltage battery 3.

According to the conventional technique, the navigation device 11 includes a GPS receiver, specifies a current location of the vehicle 2, displays the current location of the vehicle 2 on a map, and guides a travel route to a destination.

### 1.2 Configuration of Update Management Device

FIG. 2 illustrates an example of the configuration of the update management device 5.

The update management device 5 includes, for example, a first processor 30 and a first memory 31. The first memory 31 includes, for example, a volatile and/or a nonvolatile semiconductor memory, a hard disk device, and the like.

The first processor 30 is, for example, a computer including a CPU and the like. The first processor 30 may have a configuration including a ROM in which a program is written, a RAM for temporary storage of data, and the like. Then, the first processor 30 includes a reception unit 33, an update unit 34, and a management unit 35 as functional elements or functional units.

These functional elements included in the first processor 30 are implemented, for example, by the first processor 30, which is a computer, executing a first program 32 stored in the first memory 31. In addition, the first program 32 can be stored in any computer-readable storage medium. Alternatively, all or some of the functional elements included in the first processor 30 may be configured by hardware including one or more electronic circuit components.

The reception unit 33 receives an update instruction and an update program for the in-vehicle device 25 from the update management server 9, and stores the received update program in the first memory 31.

The update unit 34 instructs the in-vehicle device 25, which is an update target, to install the stored update program at a predetermined timing. In the present embodiment, the predetermined timing is when the vehicle 2 stops. The update unit 34 instructs the in-vehicle device 25 to install the update program on condition that permission to start the update operation (described later) is received from the determination unit 45 at the predetermined timing. This starts the update operation. The update unit 34 may also receive a notification of the end of installation of the update program from the in-vehicle device 25 when installation of the update program in the in-vehicle device 25 ends.

When the update unit 34 performs the update operation of the in-vehicle device 25, the management unit 35 transmits information regarding the update operation to the battery control device 1. For example, when the update unit 34 starts the update operation, the management unit 35 transmits, to the battery control device 1, a notification indicating that the update operation is about to start, a required update time which is a time required for the update operation to be started, the number of update devices which is the number of in-vehicle devices 25 to be subjected to the program update in the update operation, and information on a predicted end time which is a time at which the update operation is predicted to end. In addition, when the update unit 34 ends the update operation (that is, when the installation of the update program in the in-vehicle device 25 ends), the management unit 35 transmits a notification of the end of the update operation to the battery control device 1. The notification indicating that the update operation has ended may include the end time at which the update operation has ended.

For example, when there are a plurality of update programs that are targets of the update operation executed by the update unit 34 (including a case where there is one target in-vehicle device 25 and a case where there are a plurality of target in-vehicle devices 25), the management unit 35 transmits to the battery control device 1 information on the required update time and the predicted end time as a whole of the update operation for the plurality of update programs.

The required update time can be measured in advance by the manufacturer of the vehicle 2 for each update program and can be transmitted from the update management server 9 together with the corresponding update program, for example. The management unit 35 can calculate an in-vehicle required time by adding up the required update time of the update program to be updated, for each in-vehicle device 25 to be updated, and use the longest in-vehicle required time as an update time for the entire update operation.

### 1.3 Configuration of Battery Control Device

FIG. 2 is a diagram illustrating the configuration of the battery control device 1 according to the present embodiment.

The battery control device 1 controls a charging operation for a target battery, which is one battery mounted on the vehicle 2. In the present embodiment, the target battery is the low-voltage battery 3. In the present embodiment, the low-voltage battery 3 is charged from the high-voltage battery 4 through a charging/discharging device 22 including an appropriate voltage conversion circuit. Specifically, the battery control device 1 controls the charging operation from the high-voltage battery 4 to the low-voltage battery 3 by controlling the charging/discharging device 22.

The low-voltage battery 3 supplies power required for starting the vehicle 2 and/or power required for driving control of the vehicle 2 to the communication device 24 and the in-vehicle device 25. The low-voltage battery 3 includes a remaining amount sensor 20 that detects a remaining charge amount of the low-voltage battery 3 and a battery temperature sensor 21 that detects a battery temperature (for example, the temperature of the body of the low-voltage battery 3) of the low-voltage battery 3. The remaining charge amount is, for example, a so-called state of charge (SOC), and the unit is a ratio (%) of the current charge amount to the full charge amount.

The communication device 24 is a transceiver (transmitter/receiver, circuit) for an in-vehicle device including the battery control device 1 to communicate with another device through the communication network 7.

The in-vehicle device 25 is, for example, an electronic control unit (ECU) that includes a computer and operates by executing a program. Although three in-vehicle devices 25 are illustrated in FIG. 2, the number of in-vehicle devices 25 included in the vehicle 2 is any number. The in-vehicle devices 25 can have different functions.

The charging/discharging device 22 also controls a charging operation for the high-voltage battery 4 with power supplied from a power supply device outside the vehicle 2 through a connector 26 provided in the body of the vehicle 2. In addition, when not charging the high-voltage battery 4, the charging/discharging device 22 supplies the power from the high-voltage battery 4 to the motor for traveling 6 through the traveling control device 23. The traveling control device 23 controls the supply of power to the motor for traveling 6 to control the traveling operation of the vehicle 2.

The battery control device 1 includes a second processor 40 and a second memory 41. The second memory 41 includes, for example, a volatile and/or a nonvolatile semiconductor memory, a hard disk device, and the like.

The second processor 40 is, for example, a computer including a CPU and the like. The second processor 40 may have a configuration including a ROM in which a program is written, a RAM for temporary storage of data, and the like. Then, the second processor 40 includes an acquisition unit 43, an execution unit 44, and a determination unit 45 as functional elements or functional units.

These functional elements included in the second processor 40 are implemented, for example, by the second processor 40, which is a computer, executing the second program 42 stored in the second memory 41. In addition, the second program 42 can be stored in any computer-readable storage medium. Alternatively, all or some of the functional elements included in the second processor 40 may be configured by hardware including one or more electronic circuit components.

The acquisition unit 43 acquires predetermined information including information on an update operation, which is an operation related to program update of the in-vehicle device 25 mounted on the vehicle 2, and information on a remaining charge amount of the low-voltage battery 3, which is a target battery.

The information on the update operation may include information on the required update time, which is a time required for the update operation, and a predicted end time, which is a time at which the update operation is predicted to end.

As described above, when starting the update operation of the in-vehicle device 25, the update management device 5 (specifically, the management unit 35 of the update management device 5) transmits, to the battery control device 1, a notification indicating that the update operation about to start, a required update time which is a time required for the update operation to be started, the number of in-vehicle devices 25 which is the number of in-vehicle devices to be subjected to the program update in the update operation, and information on a predicted end time which is a time at which the update operation is predicted to end. In addition, when the executed update operation has ended, the update management device 5 transmits a notification indicating that the update operation has ended to the battery control device 1. The acquisition unit 43 receives and acquires these notifications and information transmitted from the update management device 5.

The acquisition unit 43 acquires, as predetermined information, information on the required update time and the predicted end time among the pieces of information transmitted from the update management device 5.

In addition, the information regarding the remaining charge amount of the low-voltage battery 3 included in the predetermined information can include information regarding an actual remaining charge amount that is the actual remaining charge amount of the low-voltage battery 3 and information regarding a predicted remaining charge amount that is a predicted value of the remaining charge amount of the low-voltage battery 3 at the end of the update operation.

Specifically, when there is a request for the update operation (hereinafter, also referred to as “at the time of request for an update operation”) and when the update operation ends, the acquisition unit 43 acquires an actual remaining charge amount at the time of request for the update operation and an actual remaining charge amount at the end of the update operation from the remaining amount sensor 20 provided in the low-voltage battery 3. Here, “when there is a request for an update operation” (at the time of request for an update operation) refers to when the battery control device 1 receives a “notification indicating that an update operation is about to start” from the update management device 5.

In addition, the acquisition unit 43 calculates and acquires the predicted remaining charge amount based on the number of update devices and the required update time received from the update management device 5, the average power at the time of update that is a predicted value of average power consumption per hour in the update operation per in-vehicle device 25, and the actual remaining charge amount at the time of request for the update operation. For example, the acquisition unit 43 calculates a discharge amount at the time of update, which is the total amount of discharge of the low-voltage battery 3 in the update operation, by multiplying the number of update devices by the average power at the time of update and the required update time. Then, the acquisition unit 43 calculates a predicted remaining charge amount according to the conventional technique based on the actual remaining charge amount and the updated discharge amount. Here, the above-described average power at the time of update can be calculated in advance and stored in the second memory 41.

The predetermined information acquired by the acquisition unit 43 can also include information on an appropriate temperature range that is a temperature range in which the charging efficiency, which is the ratio of the increase amount of the remaining charge amount to the power supply amount in the low-voltage battery 3, is equal to or greater than a predetermined value set in advance. For example, the information on the appropriate temperature range can be set in advance and stored in the second memory 41. The acquisition unit 43 can read and acquire information on the appropriate temperature range from the second memory 41. The appropriate temperature range can be expressed by, for example, an upper limit temperature and a lower limit temperature of the appropriate temperature range. The appropriate temperature range can be defined as, for example, a temperature range that is equal to or higher than the lower limit temperature and equal to or lower than the upper limit temperature.

The acquisition unit 43 also acquires, from the behavior tendency learning device 10, information regarding a non-use time zone, which is a time zone in which the user U of the vehicle 2 is predicted not to use the vehicle 2, as the predetermined information. The non-use time zone may be periodically acquired from the behavior tendency learning device 10 and stored in the second memory 41. The acquisition unit 43 can read and acquire the non-use time zone from the second memory 41.

The acquisition unit 43 also acquires, as the predetermined information, a first scheduled departure time, which is the departure time of the vehicle 2 scheduled by the user U at the time of request for the update operation, from the terminal device 8 of the user U of the vehicle 2 at the time of request for the update operation. In addition, when the update operation ends, the acquisition unit 43 acquires, as the predetermined information, a second scheduled departure time, which is the departure time of the vehicle 2 scheduled by the user U after the end of the update operation, from the terminal device 8 of the user U of the vehicle 2.

The execution unit 44 executes a charging operation from the high-voltage battery 4 to the low-voltage battery 3. When the update operation of the in-vehicle device 25 is started, the execution unit 44 stops the charging operation for the low-voltage battery 3. For example, the execution unit 44 stops the charging operation for the low-voltage battery 3 until the update management device 5 instructs the in-vehicle device 25 to install the update program in response to reception of the permission (described later) to start the update operation from the determination unit 45.

In the present embodiment, the execution unit 44 starts the charging operation for the low-voltage battery 3 after the end of the update operation in accordance with a result of start determination in the determination unit 45 described later. When the determination unit 45 determines to start the charging operation for the low-voltage battery 3 after the end of the update operation in the start determination, the execution unit 44 immediately starts the charging operation for the low-voltage battery 3 when the update operation ends. In addition, when the determination unit 45 determines not to start the charging operation for the low-voltage battery 3 after the end of the update operation in the start determination, the execution unit 44 does not start the charging operation for the low-voltage battery 3 until another predetermined condition (for example, the vehicle is traveling.) set in advance is satisfied even after the end of the update operation.

However, when the actual remaining charge amount of the low-voltage battery 3 becomes equal to or less than a third threshold value set in advance as the remaining charge amount with which it is difficult to guarantee the activation of the vehicle 2 at the end of the update operation, the execution unit 44 immediately starts the charging operation for the low-voltage battery 3 regardless of the result of the start determination in the determination unit 45.

As a result, when the remaining charge amount of the target battery decreases to a level at which it is difficult to guarantee the activation of the vehicle after the end of the update operation, the remaining charge amount of the target battery can be quickly recovered to a level at which the activation of the vehicle can be guaranteed.

Here, the third threshold value is a value smaller than a second threshold value, which will be described later, set in advance as a remaining charge amount that can guarantee the activation of the vehicle 2. The third threshold value may be set in advance and stored in the second memory 41, for example.

The determination unit 45 determines whether or not the execution unit 44 can execute the charging operation for the low-voltage battery 3 after the end of the update operation of the in-vehicle device 25. In the present embodiment, in particular, the determination unit 45 performs start determination as to whether or not to start the charging operation for the low-voltage battery 3 after the end of the started update operation, based on at least information on the remaining charge amount of the low-voltage battery 3, during a period from the request for the update operation to the start of the update operation. Here, “the period from the request for the update operation to the start of the update operation” specifically refers to a period from when the battery control device 1 receives a “notification indicating that the update operation is about to start” from the update management device 5 until the update management device 5 instructs the in-vehicle device 25 to install the update program.

The determination unit 45 can give permission to start the update operation to the update management device 5 when the start determination ends. In response to receiving the permission to start the update operation, the update management device 5 instructs the in-vehicle device 25 to install the update program and starts the update operation.

As described above, in the battery control device 1, when the charging operation for the low-voltage battery 3 is interrupted during the update operation of the in-vehicle device 25, whether or not the charging operation can be resumed after the end of the update operation is determined before the start of the update operation according to at least the remaining charge amount of the low-voltage battery 3. As a result, in the battery control device 1, it is possible to avoid overcharge of the low-voltage battery 3 and/or reduce the number of charge/discharge cycles while enabling required charging for the low-voltage battery 3 to be performed quickly after the end of the update operation of the in-vehicle device 25, thereby suppressing a reduction in the charging efficiency and/or the state of health of the target battery.

In the present embodiment, three threshold values of a first threshold value, a second threshold value, and a third threshold value are set in advance as threshold values related to the remaining charge amount of the low-voltage battery 3 used when the determination unit 45 makes the start determination. The first threshold value is a threshold value set in advance to avoid shortening of a life of the low-voltage battery 3 by avoiding an overcharged state of the low-voltage battery 3, and is, for example, 80%. The second threshold value is a threshold value set in advance as a remaining charge amount that can guarantee the activation of the vehicle 2, and is, for example, 30%. Here, the “remaining charge amount that can guarantee the activation of the vehicle 2” specifically refers to, for example, the minimum remaining charge amount that the low-voltage battery 3 should hold in order to accurately supply power necessary for activation of the vehicle 2 to the in-vehicle device 25.

As described above, the third threshold value is a threshold value set in advance as a remaining charge amount with which it is difficult to guarantee the activation of the vehicle 2, and is, for example, 20%. Here, the “remaining charge amount with which it is difficult to guarantee the activation of the vehicle 2” specifically refers to, for example, a remaining charge amount that may cause a case where the low-voltage battery 3 cannot accurately supply the power necessary for the activation of the vehicle 2 to the in-vehicle device 25 when the level falls below the remaining charge amount.

The second threshold value is set as a value smaller than the first threshold value, and the third threshold value is defined as a value smaller than the second threshold value. The first threshold value, the second threshold value, and the third threshold value can be set in advance and stored in the second memory 41, for example. In addition, the first threshold value, the second threshold value, and the third threshold value can be defined to change depending on conditions such as the outside air temperature.

In the present embodiment, the determination unit 45 operates in three operation modes. For example, the determination unit 45 operates in any one of the first operation mode, the second operation mode, and the third operation mode in accordance with information specifying the operation mode which is set in advance and stored in the second memory 41.

In the present embodiment, as an operation common to the above three operation modes, the determination unit 45 determines to start the charging operation for the low-voltage battery 3 after the end of the update operation on condition that the actual remaining charge amount of the low-voltage battery 3 at the time of request for the update operation is equal to or less than the first threshold value. In addition, when the actual remaining charge amount of the low-voltage battery 3 at the time of request for the update operation exceeds the first threshold value in the start determination, the determination unit 45 determines not to start the charging operation for the low-voltage battery 3 after the end of the update operation.

As a result, the battery control device 1 can reliably avoid overcharge of the target battery after the update operation.

Hereinafter, the start determination executed by the determination unit 45 in each of the first operation mode, the second operation mode, and the third operation mode will be sequentially described.

### 1.3.1 First Operation Mode

In the first operation mode, the conditions used for the start determination by the determination unit 45 include the conditions of the actual remaining charge amount of the low-voltage battery 3, the predicted remaining charge amount at the end of the update, and the appropriate temperature range as the predetermined information acquired by the acquisition unit 43.

Specifically, in the start determination, first, when the actual remaining charge amount of the low-voltage battery 3 at the time of request for the update operation exceeds the first threshold value, the determination unit 45 determines not to start the charging operation for the low-voltage battery 3 after the end of the update operation.

In the first operation mode, in particular, in the start determination, even if the actual remaining charge amount of the low-voltage battery 3 at the time of request for the update operation is equal to or less than the first threshold value, when the predicted remaining charge amount of the low-voltage battery 3 in the update operation is equal to or greater than the second threshold value and the battery temperature of the low-voltage battery 3 exceeds the upper limit temperature or is less than the lower limit temperature of the appropriate temperature range, the determination unit 45 determines not to start the charging operation for the low-voltage battery 3 after the end of the update operation.

On the other hand, in the start determination, when the actual remaining charge amount of the low-voltage battery 3 at the time of request for the update operation is equal to or less than the first threshold value, the predicted remaining charge amount of the low-voltage battery 3 in the update operation is equal to or greater than the second threshold value, and the battery temperature of the low-voltage battery 3 is equal to or higher than the lower limit temperature and equal to or lower than the upper limit temperature of the appropriate temperature range, the determination unit 45 determines to start the charging operation for the low-voltage battery 3 after the end of the update operation.

As a result, in the first mode operation, when it is predicted that the remaining charge amount that can guarantee the activation of the vehicle is secured in the low-voltage battery 3 after the end of the update operation of the in-vehicle device 25, the charging operation for the low-voltage battery 3 is not started after the update operation under the temperature conditions that are not temperature conditions in which the charging efficiency is good, and the charging operation for the low-voltage battery 3 is started after the update operation under the temperature conditions in which the charging efficiency is good. As a result, in the first operation mode, it is possible to effectively suppress a reduction in the charging efficiency and/or the state of health of the target battery.

In addition, in the start determination, when the actual remaining charge amount of the low-voltage battery 3 at the time of request for the update operation is equal to or less than the first threshold value and the predicted remaining charge amount of the low-voltage battery 3 at the end of the update is less than the second threshold value, the determination unit 45 determines to start the charging operation for the low-voltage battery 3 after the end of the update operation.

As a result, when it is predicted that it is difficult to secure the remaining charge amount that can guarantee the activation of the vehicle in the low-voltage battery 3 after the end of the update operation of the in-vehicle device 25, the charging of the low-voltage battery 3 can be resumed immediately after the end of the update operation.

As described above, when the actual remaining charge amount of the low-voltage battery 3 at the end of the update operation becomes equal to or less than the third threshold value, the execution unit 44 starts the charging operation for the low-voltage battery 3 regardless of the result of the start determination in the determination unit 45.

### 1.3.2 Second Operation Mode

In the second operation mode, the conditions used for the start determination by the determination unit 45 include information on the actual remaining charge amount of the low-voltage battery 3, the predicted end time of the update operation, the predicted remaining charge amount at the end of the update, and the non-use time zone of the user U as the predetermined information acquired by the acquisition unit 43.

Specifically, in the start determination, first, when the actual remaining charge amount of the low-voltage battery 3 at the time of request for the update operation exceeds the first threshold value or more, the determination unit 45 determines not to start the charging operation for the low-voltage battery 3 after the end of the update operation.

In the second operation mode, in particular, in the start determination, on condition that the actual remaining charge amount of the low-voltage battery 3 at the time of request for the update operation is equal to or less than the first threshold value, when the predicted end time of the update operation is not included in the non-use time zone of the user U, the determination unit 45 determines not to start the charging operation for the low-voltage battery 3 after the end of the update operation.

On the other hand, in the start determination, on condition that the actual remaining charge amount of the low-voltage battery 3 at the time of request for the update operation is equal to or less than the first threshold value, when the predicted end time of the update operation is included in the non-use time zone of the user U, the determination unit 45 determines to start the charging operation for the low-voltage battery 3 after the end of the update operation.

That is, in the second operation mode, when the predicted end time of the update operation is not included in the non-use time zone of the vehicle 2 of the user U and it is highly probable that the vehicle starts traveling soon after the end of the update operation, the charging operation for the low-voltage battery 3 can be appropriately started according to the conventional technique after the start of traveling. For this reason, the immediate charging operation after the end of the update operation is not performed. As a result, in the second operation mode, it is possible to effectively suppress a reduction in the state of health of the low-voltage battery 3 by suppressing an increase in the charge/discharge cycle of the low-voltage battery 3 under the condition of avoiding the overcharged state of the low-voltage battery 3.

More specifically, in the start determination, in a case where the actual remaining charge amount of the low-voltage battery 3 at the time of request for the update operation is equal to or less than the first threshold value and the predicted remaining charge amount at the end of the update is equal to or greater than the second threshold value, when the predicted end time of the update operation is not included in the non-use time zone of the user U, the determination unit 45 determines not to start the charging operation for the low-voltage battery 3 after the end of the update operation.

In addition, in the start determination, in a case where the actual remaining charge amount of the low-voltage battery 3 at the time of request for the update operation is equal to or less than the first threshold value and the predicted remaining charge amount at the end of the update is equal to or greater than the second threshold value, when the predicted end time of the update operation is included in the non-use time zone of the user U, the determination unit 45 determines to start the charging operation for the low-voltage battery 3 after the end of the update operation.

As a result, it is possible to effectively suppress a reduction in the state of health of the low-voltage battery 3 by suppressing an increase in the charge/discharge cycle of the low-voltage battery 3 while securing the remaining charge amount that can guarantee the activation of the vehicle after the end of the update operation under the condition of avoiding the overcharged state of the low-voltage battery 3.

In addition, in the start determination, when the actual remaining charge amount of the low-voltage battery 3 at the time of request for the update operation is equal to or less than the first threshold value and the predicted remaining charge amount at the end of the update is less than the second threshold value, the determination unit 45 determines to start the charging operation for the low-voltage battery 3 after the end of the update operation.

As a result, when it is predicted that it is difficult to secure the remaining charge amount that can guarantee the activation of the vehicle in the low-voltage battery 3 after the end of the update operation of the in-vehicle device 25, the charging of the low-voltage battery 3 can be resumed immediately after the end of the update operation.

As described above, when the actual remaining charge amount of the low-voltage battery 3 at the end of the update operation becomes equal to or less than the third threshold value, the execution unit 44 starts the charging operation for the low-voltage battery 3 regardless of the result of the start determination in the determination unit 45.

### 1.3.3 Third Operation Mode

In the third operation mode, the conditions used for the start determination by the determination unit 45 include information on the actual remaining charge amount of the low-voltage battery 3, the predicted end time of the update operation, the predicted remaining charge amount at the end of the update, and the first scheduled departure time and the second scheduled departure time of the user U as the predetermined information acquired by the acquisition unit 43.

As described above, the first scheduled departure time is the departure time of the vehicle 2 scheduled by the user U at the time of request for the update operation. In addition, the second scheduled departure time is the departure time of the vehicle 2 scheduled by the user U at the end of the update operation.

Specifically, in the start determination, first, when the actual remaining charge amount of the low-voltage battery 3 at the time of request for the update operation exceeds the first threshold value or more, the determination unit 45 determines not to start the charging operation for the low-voltage battery 3 after the end of the update operation.

In the third operation mode, in particular, in the start determination, when the actual remaining charge amount of the low-voltage battery 3 at the time of request for the update operation is equal to or less than the first threshold value and the time from the predicted end time of the update operation to the first scheduled departure time of the user U is equal to or longer than a predetermined time set in advance, the determination unit 45 determines to start the charging operation for the low-voltage battery 3 after the end of the update operation.

On the other hand, in the start determination, when the actual remaining charge amount of the low-voltage battery 3 at the time of request for the update operation is equal to or less than the first threshold value and the time from the predicted end time of the update operation to the first scheduled departure time of the user U is less than the predetermined time set in advance, the determination unit 45 determines not to start the charging operation for the low-voltage battery 3 after the end of the update operation.

That is, in the third operation mode, when the time from the predicted end time to the first scheduled departure time is less than the predetermined time and it is highly probable that the vehicle starts traveling soon after the end of the update operation, the charging operation for the target battery can be appropriately started according to the conventional technique after the start of traveling. For this reason, the immediate charging operation for the low-voltage battery 3 after the end of the update operation is not performed. As a result, according to the third operation mode, it is possible to effectively suppress a reduction in the state of health of the low-voltage battery 3 by suppressing an increase in the charge/discharge cycle of the low-voltage battery 3 under the condition of avoiding the overcharged state of the low-voltage battery 3.

However, as an exception condition, in the start determination, when the predicted remaining charge amount at the end of the update is equal to or greater than the second threshold value even if the actual remaining charge amount of the low-voltage battery 3 at the time of request for the update operation is equal to or less than the first threshold value and the time from the predicted end time of the update operation to the first scheduled departure time of the user U is equal to or longer than the predetermined time set in advance, the determination unit 45 determines not to start the charging operation for the low-voltage battery 3 after the end of the update operation.

By the application of this exception condition, even if the time from the predicted end time to the first scheduled departure time is equal to or longer than the predetermined time and it is unlikely that the vehicle will start traveling for a while after the end of the update operation, when it is expected that the remaining charge amount that can guarantee the activation of the vehicle can be secured at the end of the update operation, the immediate charging operation for the low-voltage battery 3 after the end of the update operation is not performed.

As a result, it is possible to more effectively suppress a reduction in the state of health of the low-voltage battery 3 by suppressing an increase in the charge/discharge cycle of the low-voltage battery 3 while securing the remaining charge amount that can guarantee the activation of the vehicle after the end of the update operation under the condition of avoiding the overcharged state of the low-voltage battery 3.

In addition, even when the determination unit 45 determines not to start the charging operation for the low-voltage battery 3 after the end of the update operation because the exception condition is satisfied, the execution unit 44 starts the charging operation for the low-voltage battery 3 regardless of the determination by the determination unit 45 when the predetermined exception recovery condition is satisfied after the actual end of the update operation. Specifically, the exception recovery condition is that the time from the actual end time of the update operation to the second scheduled departure time of the user U is longer than the predetermined time and the actual remaining charge amount of the low-voltage battery 3 at the end of the update operation is less than the second threshold value.

By applying the exception recovery condition, it is further determined whether or not the immediate charging operation for the low-voltage battery 3 is necessary based on the actual remaining charge amount at the end of the update operation and the latest departure time scheduled by the user. As a result, it is possible to quickly charge the low-voltage battery 3 as necessary based on a more reliable determination after the end of the update operation.

As described above, when the actual remaining charge amount of the low-voltage battery 3 at the end of the update operation becomes equal to or less than the third threshold value, the execution unit 44 starts the charging operation for the low-voltage battery 3 regardless of the result of the start determination in the determination unit 45.

### 1.4 Operation of Battery Control Device

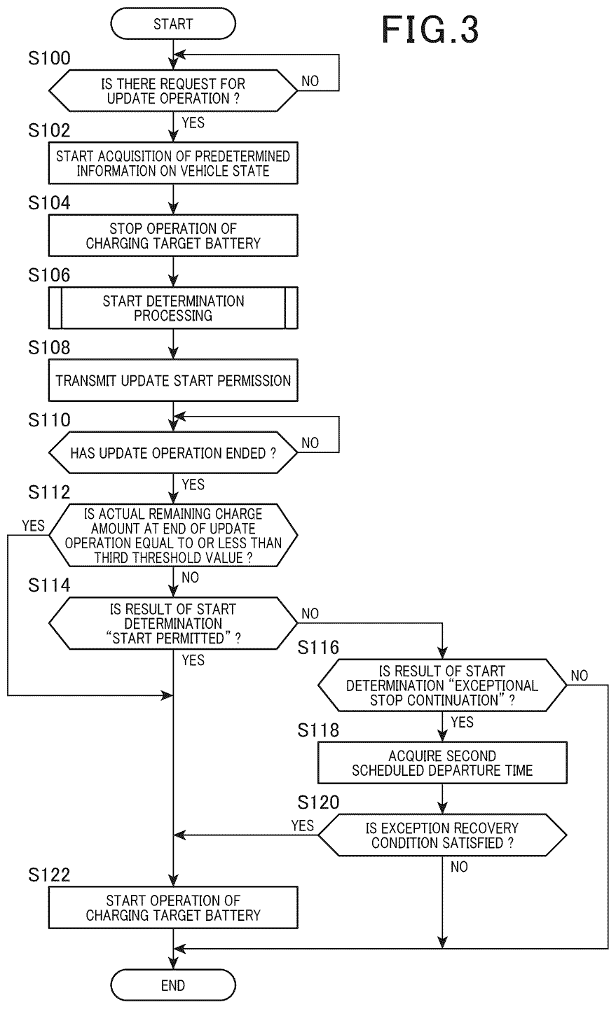

Next, the operation of the battery control device 1 will be described. FIG. 3 is a flowchart illustrating a procedure of a battery control method executed by the second processor 40 which is a computer of the battery control device 1. The process shown in FIG. 3 is started when the power of the battery control device 1 is turned on, and thereafter, is repeatedly performed until the power is turned off. In addition, FIG. 3 illustrates a process when the update operation for updating the program of the in-vehicle device 25 is performed by the update management device 5, in the process performed by the battery control device 1. When the update operation of the in-vehicle device 25 is not performed, the battery control device 1 performs a charging operation for the low-voltage battery 3 according to the conventional technique when a predetermined condition (for example, while the vehicle 2 is traveling) set in advance is satisfied.

Referring to FIG. 3, when the process is started, the acquisition unit 43 of the battery control device 1 determines whether or not a notification indicating that the update operation is about to start has been received from the update management device 5, that is, whether or not there is a request for the update operation (S100). Then, when there is no request for the update operation (S100, NO), the acquisition unit 43 returns to step S100 to repeat the process, and waits until there is a request for the update operation.

On the other hand, when a notification indicating that the update is about to start is received from the update management device 5, that is, when there is a request for an update operation (S100, YES), the acquisition unit 43 starts acquisition of predetermined information based on information regarding the update operation subsequently received from the update management device 5 or the like (S102). The details of the predetermined information are as described above. In addition, the execution unit 44 stops the charging operation for the low-voltage battery 3, which is a target battery (S104).

Then, the determination unit 45 performs start determination process for performing start determination as to whether or not to start the charging operation for the low-voltage battery 3, which is a target battery, after the end of the started update operation (S106). As described above, the start determination is performed based on at least the information on the remaining charge amount of the target battery during a period from the request for the update operation to the start of the update operation.

As described above, the result of the start determination is either the determination of “starting the charging operation after the end of the update operation” or the determination of “not starting the charging operation after the end of the update operation”. Hereinafter, the determination result that “the charging operation is started after the end of the update operation” is referred to as “start permitted”, and the determination result that “the charging operation is not started after the end of the update operation” is referred to as “stop continued”. It is assumed that the result of the determination made by the determination unit 45 in the third operation mode by the application of the exception condition described above that “the charging operation is not started after the end of the update operation” is referred to as “exceptional stop continuation” so as to be distinguished from other “stop continued”.

Then, the determination unit 45 transmits a permission to start the update operation (hereinafter, referred to as “update start permission”) to the update management device 5 (S108). As described above, in response to receiving the update start permission, the update management device 5 instructs the in-vehicle device 25 to install the update program and starts the update operation.

Then, the execution unit 44 determines whether or not the update operation has ended (S110). Whether or not the update operation has ended can be determined according to whether or not the acquisition unit 43 has received a notification indicating that the update operation has ended from the update management device 5. Then, when the update operation is not ended (S110, NO), the execution unit 44 returns to step S110 to repeat the process, and waits for the end of the update operation.

On the other hand, when the update operation has ended (S110, YES), the execution unit 44 determines whether or not the current (that is, at the end of the update operation) actual remaining charge amount of the low-voltage battery 3 is equal to or less than the third threshold value (S112).

Then, when the actual remaining charge amount of the low-voltage battery 3 exceeds the third threshold value (S112, NO), the execution unit 44 determines whether or not the result of the start determination in the start determination process of step S106 is “start permitted” (S114). When the result of the start determination is “start permitted” (S114, YES), the execution unit 44 starts the charging operation for the low-voltage battery 3 (S122) and ends this process.

On the other hand, when the actual remaining charge amount of the low-voltage battery 3 is equal to or less than the third threshold value in step S112 (S112, YES), the execution unit 44 proceeds to the processing of step S122 to start the charging operation for the low-voltage battery 3 that is a target battery.

In addition, on the other hand, when the result of the start determination is not “start permitted” in step S114 (S114, NO), the execution unit 44 determines whether or not the result of the start determination is “exceptional stop continuation” (S116).

Then, when the result of the start determination is “exceptional stop continuation” (S116, YES), the acquisition unit 43 acquires the second scheduled departure time from the terminal device 8 of the user U (S118). Then, the execution unit 44 determines whether or not the above-described exception recovery condition is satisfied (S120). As described above, the exception recovery condition is that the time from the actual end time of the update operation to the second scheduled departure time is longer than the predetermined time and the actual remaining charge amount of the low-voltage battery 3 at the end of the update operation is less than the second threshold value.

Then, when the exception recovery condition is satisfied (S120, YES), the execution unit 44 proceeds to the processing of step S122 to start the charging operation for the low-voltage battery 3 that is a target battery. On the other hand, when the exception recovery condition is not satisfied (S120, NO), the process ends without starting the charging operation for the low-voltage battery 3.

In addition, on the other hand, when the result of the start determination is not “exceptional stop continuation” in step S116 (S116, NO), the execution unit 44 ends the process without starting the charging operation for the low-voltage battery 3 without determining the exception recovery condition in step S120.

Here, steps S102 and S104 in FIG. 3 correspond to the first step and the second step in the present disclosure. In addition, step S106 in FIG. 3 corresponds to the third step in the present disclosure.

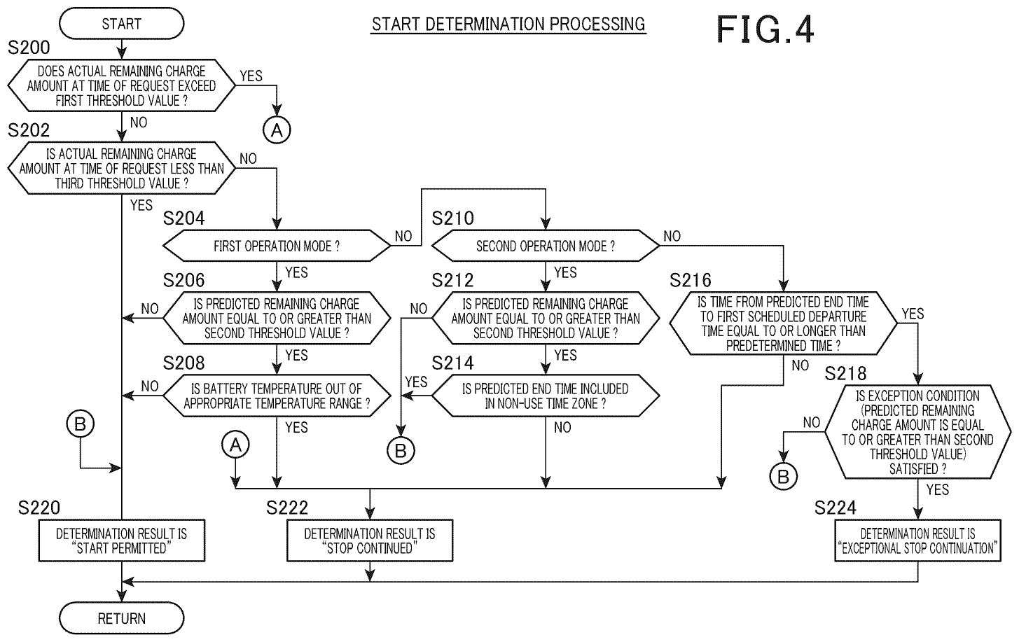

Next, specific processing of the start determination process (step S106) in FIG. 3 will be described. FIG. 4 is a flowchart illustrating the procedure of start determination process performed by the determination unit 45.

When the process is started, first, the determination unit 45 determines whether or not the actual remaining charge amount of the low-voltage battery 3 at the time of request for the update operation exceeds the first threshold value (S200). Then, when the actual remaining charge amount at the time of request for the update operation exceeds the first threshold value (S200, YES), the determination unit 45 sets the determination result to “stop continued” (S222). That is, the determination unit 45 determines that the charging operation is not started after the end of the update operation. Thereafter, the determination unit 45 returns to the processing of step S108 in FIG. 3.

On the other hand, when the actual remaining charge amount at the time of request for the update operation is equal to or less than the first threshold value (S200, NO), the determination unit 45 further determines whether or not the actual remaining charge amount at the time of request for the update operation is equal to or less than the third threshold value (S202). Then, when the actual remaining charge amount is equal to or less than the third threshold value (S202, YES), the determination unit 45 sets the determination result to “start permitted” (S220). That is, the determination unit 45 determines that “the charging operation is started after the end of the update operation”. Thereafter, the determination unit 45 returns to the processing of step S108 in FIG. 3.

On the other hand, when the actual remaining charge amount at the time of request for the update operation exceeds the third threshold value in step S202 (S202, NO), the determination unit 45 determines whether or not the operation mode that is designated (hereinafter, a designated operation mode) is the first operation mode (S204).

Then, when the designated operation mode is the first operation mode (S204, YES), the determination unit 45 determines whether or not the predicted remaining charge amount at the end of the update is equal to or greater than the second threshold value (S206). Then, when the predicted remaining charge amount at the end of the update is equal to or greater than the second threshold value (S206, YES), the determination unit 45 determines whether or not the battery temperature of the low-voltage battery 3 is out of the appropriate temperature range (S208). Here, “the battery temperature is out of the appropriate temperature range” means that the battery temperature exceeds the upper limit temperature of the appropriate temperature range or is less than the lower limit temperature.

Then, when the battery temperature is out of the appropriate temperature range (S208, YES), the determination unit 45 sets the determination result to “stop continued” (S222).

On the other hand, when the predicted remaining charge amount is less than the second threshold value in step S206 (S206, NO) and when the battery temperature is within the appropriate temperature range in step S208 (S208, NO), the determination unit 45 sets the determination result to “start permitted” (S220).

On the other hand, when the designated operation mode is not the first operation mode in step S204 (S204, NO), the determination unit 45 determines whether or not the designated operation mode is the second operation mode (S210).

Then, when the designated operation mode is the second operation mode (S210, YES), the determination unit 45 determines whether or not the predicted remaining charge amount at the end of the update is equal to or greater than the second threshold value (S212). Then, when the predicted remaining charge amount is equal to or greater than the second threshold value (S212, YES), the determination unit 45 determines whether or not the predicted end time of the update operation is included in the non-use time zone of the user U (S214). Then, when the predicted end time is not included in the non-use time zone (S214, NO), the determination unit 45 sets the determination result to “stop continued” (S222).

On the other hand, when the predicted remaining charge amount is less than the second threshold value in step S212 (S212, NO) and when the predicted end time is included in the non-use time zone in step S214 (S214, YES), the determination unit 45 sets the determination result to “start permitted” (S220).

On the other hand, when the designated operation mode is not the second operation mode in step S210 (S210, NO), the determination unit 45 executes the third operation mode. That is, the determination unit 45 determines whether or not the time from the predicted end time to the first scheduled departure time is equal to or longer than a predetermined time set in advance (S216).

Then, when the time from the predicted end time to the first scheduled departure time is less than the predetermined time (S216, NO), the determination unit 45 sets the determination result to “stop continued” (S222).

On the other hand, when the time from the predicted end time to the first scheduled departure time is equal to or longer than the predetermined time (S216, YES), the determination unit 45 determines whether or not the above-described exception condition is satisfied (S218). As described above, the exception condition is that the predicted remaining charge amount at the end of the update is equal to or greater than the second threshold value.

Then, when the exception condition is satisfied (S218, YES), the determination unit 45 determines that “the charging operation is not started after the end of the update operation”, and sets the determination result to “exceptional stop continuation”. On the other hand, when the exception condition is not satisfied (S218, NO), the determination unit 45 sets the determination result to “start permitted” (S220).

### 2. Other Embodiments

The behavior tendency learning device 10 does not necessarily have to be mounted on the vehicle 2, and may be a server device communicably connected to the vehicle 2 through the communication network 7.

In addition, the target battery may be the high-voltage battery 4. In a case where the target battery is the high-voltage battery 4, when there is a request for the update operation or the update operation is started, the battery control device 1 can interrupt the external power supply from the power supply device outside the vehicle 2 to the high-voltage battery 4, and determine whether or not the operation for external power supply to the high-voltage battery 4 can be restored after the end of the update operation.

In addition, the determination unit 45 may determine whether or not to start the charging operation for the target battery after the end of the update operation, based on the information on the remaining charge amount of the target battery, during a period from the request for the update operation to the start of the update operation. In addition, the present invention is not limited to the configuration of the above embodiment, and can be practiced in various embodiments without departing from the gist thereof.

### 3. Configurations Supported by Above Embodiment

The above embodiment supports the following configurations.
(Configuration 1) A battery control device that controls a charging operation for a target battery that is one battery mounted on a vehicle, the battery control device including: an acquisition unit that acquires predetermined information including information on an update operation, which is an operation related to program update of an in-vehicle device mounted on the vehicle, and information on a remaining charge amount of the target battery; an execution unit that executes the charging operation; and a determination unit that determines whether or not to execute the charging operation in the execution unit after end of the update operation, wherein the execution unit stops the charging operation when the update operation is started, and the determination unit performs start determination as to whether or not to start the charging operation after end of the started update operation, based on at least the information on the remaining charge amount of the target battery, during a period from a request for the update operation to start of the update operation.

According to the battery control device of Configuration 1, when the charging operation of the target battery is interrupted during the update operation of the in-vehicle device, whether or not to restart the charging operation after the end of the update operation is determined before the start of the update operation according to at least the remaining charge amount of the target battery. Therefore, it is possible to suppress a reduction in the charging efficiency and/or the state of health of the target battery by avoiding overcharge of the target battery and/or reducing the number of charge/discharge cycles while enabling quick charging for the target battery after the end of the update operation.
(Configuration 2) The battery control device according to Configuration 1, wherein, in the start determination, when an actual remaining charge amount that is an actual remaining charge amount of the target battery at the time of request for the update operation is equal to or less than a first threshold value set in advance to avoid shortening of a life of the target battery by avoiding an overcharged state of the target battery, the determination unit determines to start the charging operation after the end of the update operation, and when the actual remaining charge amount at the time of request for the update operation exceeds the first threshold value, the determination unit determines not to start the charging operation after the end of the update operation.

According to the battery control device of Configuration 2, it is possible to reliably avoid overcharge of the target battery after the update operation.
(Configuration 3) The battery control device according to Configuration 2, wherein the predetermined information includes information on a predicted remaining charge amount that is a predicted value of the remaining charge amount of the target battery at the end of the update operation and information on an appropriate temperature range that is a temperature range of the target battery in which a charging efficiency, which is a ratio of an increase amount of the remaining charge amount to a power supply amount, in the target battery is equal to or greater than a predetermined value set in advance, and in the start determination, even if the actual remaining charge amount at the time of request for the update operation is equal to or less than the first threshold value, when the predicted remaining charge amount is equal to or greater than a predetermined second threshold value, which is set in advance as a remaining charge amount that guarantees activation of the vehicle, and a temperature of the target battery exceeds an upper limit temperature of the appropriate temperature range or is less than a lower limit temperature of the appropriate temperature range, the determination unit determines not to start the charging operation after the end of the update operation.

According to the battery control device of Configuration 3, when it is expected that the remaining charge amount that can guarantee the activation of the vehicle is secured after the end of the update operation, the charging operation is not started after the update operation, and when it is difficult to secure the remaining charge amount that can guarantee the activation of the vehicle, the charging operation is started after the update operation under the temperature condition in which the charging efficiency is good. As a result, in the battery control device of Configuration 3, it is possible to effectively suppress a reduction in the charging efficiency and/or the state of health of the target battery.
(Configuration 4) The battery control device according to Configuration 3, wherein, when an actual remaining charge amount that is an actual remaining charge amount of the target battery at the end of the update operation becomes equal to or less than a third threshold value that is smaller than the second threshold value and is set in advance as a remaining charge amount with which it is difficult to guarantee activation of the vehicle, the execution unit starts the charging operation regardless of a result of the start determination in the determination unit.

According to the battery control device of Configuration 4, when the remaining charge amount of the target battery decreases to a level at which it is difficult to guarantee the activation of the vehicle after the end of the update operation, the remaining charge amount of the target battery can be quickly recovered to a level at which the activation of the vehicle can be guaranteed.
(Configuration 5) The battery control device according to Configuration 2, wherein the predetermined information includes information on a predicted end time that is a time at which the update operation is predicted to end and information on a non-use time zone in which a user of the vehicle is predicted not to use the vehicle, in the start determination, on condition that the actual remaining charge amount at the time of request for the update operation is equal to or less than the first threshold value, when the predicted end time is not included in the non-use time zone, the determination unit determines not to start the charging operation after the end of the update operation, and when the predicted end time is included in the non-use time zone, the determination unit determines to start the charging operation after the end of the update operation.

In the battery control device of Configuration 5, when the predicted end time is not included in the non-use time zone and it is highly probable that the vehicle starts traveling soon after the end of the update operation, the charging operation for the target battery can be appropriately started according to the conventional technique after the start of traveling. For this reason, the immediate charging operation after the end of the update operation is not performed. Therefore, according to the battery control device of Configuration 5, it is possible to effectively suppress a reduction in the state of health of the target battery by suppressing an increase in the charge/discharge cycle of the target battery under the condition of avoiding the overcharged state of the target battery.
(Configuration 6) The battery control device according to Configuration 5, wherein the predetermined information includes information on a predicted remaining charge amount that is a predicted value of the remaining charge amount of the target battery at the end of the update operation, in the start determination, in a case where the actual remaining charge amount at the time of request for the update operation is equal to or less than the first threshold value and the predicted remaining charge amount is equal to or greater than a second threshold value that is smaller than the first threshold value and is set in advance as a remaining charge amount that guarantees activation of the vehicle, when the predicted end time is not included in the non-use time zone, the determination unit determines not to start the charging operation after the end of the update operation, and when the predicted end time is included in the non-use time zone, the determination unit determines to start the charging operation after the end of the update operation.

According to the battery control device of Configuration 6, it is possible to effectively suppress a reduction in the state of health of the target battery by suppressing an increase in the charge/discharge cycle of the target battery while securing the remaining charge amount that can guarantee the activation of the vehicle after the end of the update operation under the condition of avoiding the overcharged state of the target battery.
(Configuration 7) The battery control device according to Configuration 6, wherein, when an actual remaining charge amount that is an actual remaining charge amount of the target battery at the end of the update operation becomes equal to or less than a third threshold value that is smaller than the second threshold value and is set in advance as a remaining charge amount with which it is difficult to guarantee activation of the vehicle, the execution unit starts the charging operation regardless of a result of the start determination in the determination unit.

According to the battery control device of Configuration 7, when it is predicted that it is difficult to secure the remaining charge amount that can guarantee the activation of the vehicle in the target battery after the end of the update operation, the charging of the target battery can be resumed immediately after the end of the update operation.
(Configuration 8) The battery control device according to Configuration 2, wherein the predetermined information includes information on a predicted end time that is a time at which the update operation is predicted to end, at the time of request for the update operation, the acquisition unit acquires, from a terminal device of a user of the vehicle, a first scheduled departure time that is a departure time of the vehicle scheduled by the user at the time of request for the update operation, in the start determination, when the actual remaining charge amount at the time of request for the update operation is equal to or less than the first threshold value and a time from the predicted end time to the first scheduled departure time is equal to or longer than a predetermined time set in advance, the determination unit determines to start the charging operation after the end of the update operation, and when the actual remaining charge amount at the time of request for the update operation is equal to or less than the first threshold value and the time from the predicted end time to the first scheduled departure time is less than the predetermined time set in advance, the determination unit determines not to start the charging operation after the end of the update operation.

In the battery control device of Configuration 8, when the time from the predicted end time to the first scheduled departure time is less than the predetermined time and it is highly probable that the vehicle starts traveling soon after the end of the update operation, the charging operation for the target battery can be appropriately started according to the conventional technique after the start of traveling. For this reason, an immediate charging operation after the end of the update operation is not performed. Therefore, according to the battery control device of Configuration 8, it is possible to effectively suppress a reduction in the state of health of the target battery by suppressing an increase in the charge/discharge cycle of the target battery under the condition of avoiding the overcharged state of the target battery.
(Configuration 9) The battery control device according to Configuration 8, wherein the predetermined information includes information on a predicted remaining charge amount that is a predicted value of the remaining charge amount of the target battery at the end of the update operation, and in the start determination, even if the actual remaining charge amount at the time of request for the update operation is equal to or less than the first threshold value and the time from the predicted end time to the first scheduled departure time is equal to or greater than the predetermined time, when the predicted remaining charge amount is equal to or greater than a second threshold value that is smaller than the first threshold value and is set in advance as a remaining charge amount that guarantees activation of the vehicle, the determination unit determines not to start the charging operation after the end of the update operation.

In the battery control device of Configuration 9, even if the time from the predicted end time to the first scheduled departure time is equal to or longer than the predetermined time and it is unlikely that the vehicle will start traveling for a while after the end of the update operation, when it is expected that the remaining charge amount that can guarantee the activation of the vehicle can be secured at the end of the update operation, an immediate charging operation after the end of the update operation is not performed. Therefore, in the battery control device of configuration 9, it is possible to more effectively suppress a reduction in the state of health of the target battery by suppressing an increase in the charge/discharge cycle of the target battery while securing the remaining charge amount that can guarantee the activation of the vehicle after the end of the update operation under the condition of avoiding the overcharged state of the target battery.
(Configuration 10) The battery control device according to Configuration 9, wherein, when the actual remaining charge amount at the time of request for the update operation is equal to or less than the first threshold value and the time from the predicted end time to the first scheduled departure time is equal to or greater than the predetermined time, the predicted remaining charge amount is equal to or greater than the second threshold value, and the determination unit determines not to start the charging operation after the end of the update operation, the acquisition unit acquires a second scheduled departure time, which is a departure time of the vehicle scheduled by the user at the end of the update operation, from the terminal device of the user at the end of the update operation, and when a time from the end time of the update operation to the second scheduled departure time is longer than a predetermined time and an actual remaining charge amount, which is an actual remaining charge amount of the target battery at the end of the update operation, is less than the second threshold value, the execution unit starts a charging operation for the target battery regardless of a result of the start determination in the determination unit.

In the battery control device of Configuration 10, it is determined whether or not the immediate charging operation for the target battery is necessary based on the actual remaining charge amount at the end of the update operation and the latest departure time scheduled by the user. Therefore, according to the battery control device of Configuration 10, it is possible to quickly charge the target battery as necessary based on a more reliable determination after the end of the update operation.
(Configuration 11) The battery control device according to any one of Configurations 1 to 10, wherein the target battery is charged from a high-voltage battery having a higher output voltage than the target battery and mounted on the vehicle.

According to the battery control device of Configuration 11, by controlling the charging operation for the target battery that is charged from another high-voltage battery (for example, a battery that supplies power to the vehicle's drive device) mounted on the vehicle, it is possible to efficiently utilize the power resources within the vehicle.
(Configuration 12) A battery control method executed by a computer of a battery control device that controls a charging operation for a target battery that is one battery mounted on a vehicle, the battery control method including: a first step of acquiring predetermined information including information on an update operation, which is an operation related to program update of an in-vehicle device mounted on the vehicle, and information on a remaining charge amount of the target battery; a second step of stopping the charging operation when the update operation is started; and a third step of determining whether or not to execute the charging operation after end of the update operation, wherein in the third step, start determination as to whether or not to start the charging operation after end of the started update operation is performed, based on at least the information on the remaining charge amount of the target battery, during a period from a request for the update operation to start of the update operation.

According to the battery control method of Configuration 12, when the charging operation of the target battery is interrupted during the update operation of the in-vehicle device, whether or not to restart the charging operation after the end of the update operation is determined during the execution of the update operation according to at least the remaining charge amount of the target battery. Therefore, it is possible to suppress a reduction in the charging efficiency and/or the state of health of the target battery by avoiding overcharge of the target battery and/or reducing the number of charge/discharge cycles while enabling quick charging for the target battery after the end of the update operation.

### REFERENCE SIGNS LIST

1 BATTERY CONTROL DEVICE
2 VEHICLE
3 LOW-VOLTAGE BATTERY (TARGET BATTERY)
4 HIGH-VOLTAGE BATTERY
5 UPDATE MANAGEMENT DEVICE
6 MOTOR FOR TRAVELING
7 COMMUNICATION NETWORK
8 TERMINAL DEVICE
9 UPDATE MANAGEMENT SERVER
10 BEHAVIOR TENDENCY LEARNING DEVICE
11 NAVIGATION DEVICE
20 REMAINING AMOUNT SENSOR
21 BATTERY TEMPERATURE SENSOR
22 CHARGING/DISCHARGING DEVICE
23 TRAVELING CONTROL DEVICE
24 COMMUNICATION DEVICE
25 IN-VEHICLE DEVICE
26 CONNECTOR
30 FIRST PROCESSOR
31 FIRST MEMORY
32 FIRST PROGRAM
33 RECEPTION UNIT
34 UPDATE UNIT
35 MANAGEMENT UNIT
40 SECOND PROCESSOR
41 SECOND MEMORY
42 SECOND PROGRAM
43 ACQUISITION UNIT
44 EXECUTION UNIT
45 DETERMINATION UNIT
U USER

What is claimed is:

1. A battery control device that controls a charging operation for a target battery that is one battery mounted on a vehicle,
the battery control device comprising:
an acquisition unit that acquires predetermined information including information on an update operation, which is an operation related to program update of an in-vehicle device mounted on the vehicle, and information on a remaining charge amount of the target battery;
an execution unit that executes the charging operation; and
a determination unit that determines whether or not to execute the charging operation in the execution unit after end of the update operation, wherein
the execution unit stops the charging operation when the update operation is started, and
the determination unit performs start determination as to whether or not to start the charging operation after end of the started update operation, based on at least the information on the remaining charge amount of the target battery, during a period from a request for the update operation to start of the update operation.

2. The battery control device according to claim 1, wherein
in the start determination, when an actual remaining charge amount that is an actual remaining charge amount of the target battery at the time of request for the update operation is equal to or less than a first threshold value set in advance to avoid shortening of a life of the target battery by avoiding an overcharged state of the target battery, the determination unit determines to start the charging operation after the end of the update operation, and
when the actual remaining charge amount at the time of request for the update operation exceeds the first threshold value, the determination unit determines not to start the charging operation after the end of the update operation.

3. The battery control device according to claim 2, wherein
the predetermined information includes information on a predicted remaining charge amount that is a predicted value of the remaining charge amount of the target battery at the end of the update operation and information on an appropriate temperature range that is a temperature range of the target battery in which a charging efficiency, which is a ratio of an increase amount of the remaining charge amount to a power supply amount, in the target battery is equal to or greater than a predetermined value set in advance, and
in the start determination,
even if the actual remaining charge amount at the time of request for the update operation is equal to or less than the first threshold value,
when the predicted remaining charge amount is equal to or greater than a predetermined second threshold value, which is set in advance as a remaining charge amount that guarantees activation of the vehicle, and a temperature of the target battery exceeds an upper limit temperature of the appropriate temperature range or is less than a lower limit temperature of the appropriate temperature range, the determination unit determines not to start the charging operation after the end of the update operation.

4. The battery control device according to claim 3, wherein
when an actual remaining charge amount that is an actual remaining charge amount of the target battery at the end of the update operation becomes equal to or less than a third threshold value that is smaller than the second threshold value and is set in advance as a remaining charge amount with which it is difficult to guarantee activation of the vehicle, the execution unit starts the charging operation regardless of a result of the start determination in the determination unit.

5. The battery control device according to claim 2, wherein
the predetermined information includes information on a predicted end time that is a time at which the update operation is predicted to end and information on a non-use time zone in which a user of the vehicle is predicted not to use the vehicle,
in the start determination,
on condition that the actual remaining charge amount at the time of request for the update operation is equal to or less than the first threshold value,
when the predicted end time is not included in the non-use time zone, the determination unit determines not to start the charging operation after the end of the update operation, and
when the predicted end time is included in the non-use time zone, the determination unit determines to start the charging operation after the end of the update operation.

6. The battery control device according to claim 5, wherein
the predetermined information includes information on a predicted remaining charge amount that is a predicted value of the remaining charge amount of the target battery at the end of the update operation,
in the start determination,
in a case where the actual remaining charge amount at the time of request for the update operation is equal to or less than the first threshold value and the predicted remaining charge amount is equal to or greater than a second threshold value that is smaller than the first threshold value and is set in advance as a remaining charge amount that guarantees activation of the vehicle,
when the predicted end time is not included in the non-use time zone, the determination unit determines not to start the charging operation after the end of the update operation, and
when the predicted end time is included in the non-use time zone, the determination unit determines to start the charging operation after the end of the update operation.

7. The battery control device according to claim 6, wherein
when an actual remaining charge amount that is an actual remaining charge amount of the target battery at the end of the update operation becomes equal to or less than a third threshold value that is smaller than the second threshold value and is set in advance as a remaining charge amount with which it is difficult to guarantee activation of the vehicle, the execution unit starts the charging operation regardless of a result of the start determination in the determination unit.

8. The battery control device according to claim 2, wherein
the predetermined information includes information on a predicted end time that is a time at which the update operation is predicted to end,
at the time of request for the update operation, the acquisition unit acquires, from a terminal device of a user of the vehicle, a first scheduled departure time that is a departure time of the vehicle scheduled by the user at the time of request for the update operation,
in the start determination,
when the actual remaining charge amount at the time of request for the update operation is equal to or less than the first threshold value and a time from the predicted end time to the first scheduled departure time is equal to or longer than a predetermined time set in advance, the determination unit determines to start the charging operation after the end of the update operation, and
when the actual remaining charge amount at the time of request for the update operation is equal to or less than the first threshold value and the time from the predicted end time to the first scheduled departure time is less than the predetermined time set in advance, the determination unit determines not to start the charging operation after the end of the update operation.

9. The battery control device according to claim 8, wherein
the predetermined information includes information on a predicted remaining charge amount that is a predicted value of the remaining charge amount of the target battery at the end of the update operation, and
in the start determination,
even if the actual remaining charge amount at the time of request for the update operation is equal to or less than the first threshold value and the time from the predicted end time to the first scheduled departure time is equal to or greater than the predetermined time, when the predicted remaining charge amount is equal to or greater than a second threshold value that is smaller than the first threshold value and is set in advance as a remaining charge amount that guarantees activation of the vehicle, the determination unit determines not to start the charging operation after the end of the update operation.

10. The battery control device according to claim 9, wherein
when the actual remaining charge amount at the time of request for the update operation is equal to or less than the first threshold value and the time from the predicted end time to the first scheduled departure time is equal to or greater than the predetermined time, the predicted remaining charge amount is equal to or greater than the second threshold value, and the determination unit determines not to start the charging operation after the end of the update operation,
the acquisition unit acquires a second scheduled departure time, which is a departure time of the vehicle scheduled by the user at the end of the update operation, from the terminal device of the user at the end of the update operation, and
when a time from the end time of the update operation to the second scheduled departure time is longer than a predetermined time and an actual remaining charge amount, which is an actual remaining charge amount of the target battery at the end of the update operation, is less than the second threshold value,
the execution unit starts a charging operation for the target battery regardless of a result of the start determination in the determination unit.

11. The battery control device according to claim 1, wherein
the target battery is charged from a high-voltage battery having a higher output voltage than the target battery and mounted on the vehicle.

12. A battery control method executed by a computer of a battery control device that controls a charging operation for a target battery that is one battery mounted on a vehicle,
the battery control method comprising:
a first step of acquiring predetermined information including information on an update operation, which is an operation related to program update of an in-vehicle device mounted on the vehicle, and information on a remaining charge amount of the target battery;
a second step of stopping the charging operation when the update operation is started; and
a third step of determining whether or not to execute the charging operation after end of the update operation, wherein
in the third step, start determination as to whether or not to start the charging operation after end of the started update operation is performed, based on at least the information on the remaining charge amount of the target battery, during a period from a request for the update operation to start of the update operation.
